(19) United States
(12) Patent Application Publication
(10) Pub. No.: US 2019/0197585 A1
(43) Pub. Date: Jun. 27, 2019

(54) SYSTEMS AND METHODS FOR DATA STORAGE AND RETRIEVAL WITH ACCESS CONTROL

(71) Applicant: PayPal, Inc., San Jose, CA (US)

(72) Inventors: Gregory Sylvester, II, San Jose, CA (US); Prashant Gaurav, Fremont, CA (US); Tijana Dwight, Santa Clara, CA (US); Jan Ake Rosen, Mountain View, CA (US)

(73) Assignee: PayPal, Inc., San Jose, CA (US)

(21) Appl. No.: 15/854,550

(22) Filed: Dec. 26, 2017

(51) Int. Cl. G06Q 30/02; G06F 15/18; G06N 5/04

(52) U.S. Cl. CPC G06Q 30/0269; G06N 5/046; G06F 15/18; G06Q 30/0204

(57) ABSTRACT

Various systems, mediums, and methods for storing and retrieving data include a non-transitory memory and one or more hardware processors coupled to the non-transitory memory and configured to read instructions from the non-transitory memory to cause the system to perform operations. The operations include obtaining base data associated with a first entity, generating predictive data based on the base data using a predictive model, and providing the predictive data to a second entity. The predictive model includes a plurality of model parameters learned according to a supervised learning process. The base data includes access-restricted data associated with the first entity, and the predictive data does not include the access-restricted data.

### TECHNICAL FIELD

The present invention is generally related to electronic data storage and access, and more particularly to access controlled data storage.

### BACKGROUND

In recent years, the amount of data collected by various technologies has grown immeasurably. This trend applies in commercial contexts (e.g., consumer-related data), non-commercial contexts (e.g., healthcare-related data), and virtually every other modern technology context. For example, more than ever before, transactions (including commercial and non-commercial transactions) and other types of interactions are logged and stored for record-keeping and analysis.

In parallel with the rise of data collection, data-driven applications and technologies have proliferated. Emerging tools for making sense of large and/or heterogeneous data sets, such as big data and artificial intelligence, allow data to be used for a wide variety of practical applications. For example, data pertaining to individuals and other entities is used by merchants to provide customized advertising and shopping experiences, by healthcare professionals to provide tailored healthcare, by law enforcement officials to track criminal activity, by academics to conduct studies, and/or the like.

Accordingly, it would be desirable to develop improved systems and methods for storing and retrieving data associated with individuals and other types of entities.

### BRIEF DESCRIPTION OF THE DRAWINGS

FIG. 1 is a simplified diagram of a system for data storage and retrieval according to some embodiments.

FIG. 2 is a simplified diagram of a response template according to some embodiments.

FIG. 3 is a simplified diagram of a method 300 for retrieving data associated with a first entity, such as first entity 110, according to some embodiments.

FIG. 4 is a simplified diagram of a method 400 for generating derivative data from base data according to some embodiments

Embodiments of the present disclosure and their advantages may be understood by referring to the detailed description herein. It should be appreciated that reference numerals may be used to illustrate various elements and features provided in the figures. The figures may illustrate various examples for purposes of illustration and explanation related to the embodiments of the present disclosure and not for purposes of any limitation.

### DETAILED DESCRIPTION

Despite the widespread and increasing availability of data pertaining to individuals and other entities, many data sets are incomplete and/or offer no more than a partial picture of an individual's activities. For example, a merchant may track and log a customer's purchasing history with that particular merchant, or a provider of a funding instrument may track and log a customer's purchasing history using that particular funding instrument (e.g., a credit card, online payment account, and/or the like). However, the merchant or the provider may lack a broader picture of the individual's purchasing activities, as they may not have access to purchase information associated with other merchants or providers that the individual uses. Likewise, a healthcare provider may track and log a patient's visits with that particular provider, but may not have access to information associated with other healthcare providers that the patient uses. Similarly, an entity (e.g., a merchant, healthcare provider, etc.) seeking to build a new relationship with an individual may not have access to any data at all associated with the individual.

A possible cure to the deficiency of accessible data is to pool or otherwise share data pertaining to the target individual among various entities. By sharing data, a more complete picture of the target individual's activities may be obtained. However, there are various technical, legal, and/or practical impediments to this approach. For example, many data sets include data that is sensitive in nature, such as personally identifying information and/or information that can be used to obtain unauthorized access to accounts. Sharing of such data may be restricted and/or limited. Accordingly, it would be desirable to develop improved systems and methods for sharing data associated with a target entity, particularly when the data includes sensitive and/or access-restricted data associated with the target entity.

According to some embodiments, a system for storing and retrieving data may include a non-transitory memory and one or more hardware processors coupled to the non-transitory memory and configured to read instructions from the non-transitory memory to cause the system to perform operations. The operations include obtaining base data associated with a first entity, generating predictive data based on the base data using a predictive model, and providing the predictive data to a second entity. The predictive model includes a plurality of model parameters learned according to a supervised learning process. The base data includes access-restricted data associated with the first entity, and the predictive data does not include the access-restricted data.

According to some embodiments, a non-transitory machine-readable medium may have stored thereon machine-readable instructions executable to cause a machine to perform operations. The operations may include obtaining base data associated with a first entity, generating predictive data based on the base data using a predictive model, and providing the predictive data to a second entity based on an access level of the second entity. The predictive model may include a plurality of model parameters learned according to a supervised learning process. The base data includes access-restricted data associated with the first entity, and the predictive data does not include the access-restricted data.

According to some embodiments, a method for retrieving data associated with a first entity may include receiving a request from a second entity to access the data associated with the first entity, determining an access level of the second entity, determining, based on the access level, derivative data that the second entity has permission to access, generating a response that includes the derivative data, and transmitting the response to the second entity. The derivative data may be derived from base data that includes access-restricted data associated with the first entity.

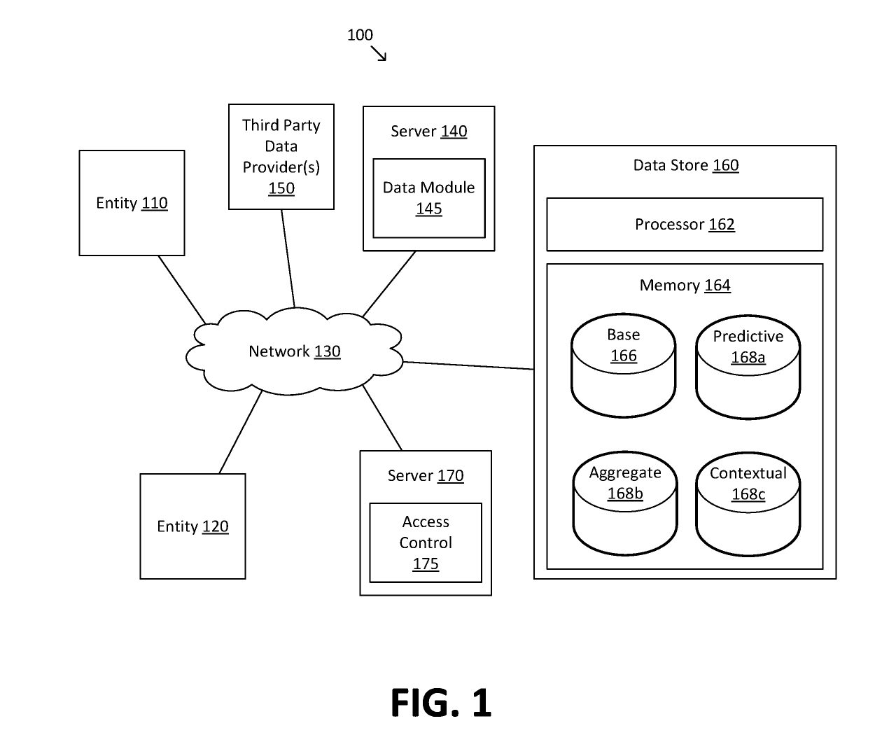

FIG. 1 is a simplified diagram of a system 100 for data storage and retrieval according to some embodiments. According to some embodiments, system 100 may collect and/or maintain data associated with a first entity 110. System 100 may further provide services to allow a second entity 120 to access the data associated with first entity 110. For example, second entity 120 may be a merchant and first entity 110 may be a prospective customer of the merchant. Accordingly, second entity 120 may desire to access data associated with previous purchases made by first entity 110 in order to generate a targeted sales pitch. In further examples, second entity 120 may be a website provider and first entity 110 may be a visitor to the website. Accordingly, second entity 120 may desire to access web browsing data associated with first entity 110 in order to customize content and/or advertisements displayed to first entity 110. In some embodiments, second entity 120 may be a provider of an application (e.g., a digital assistant, a chatbot, and/or the like), in which case second entity 120 may desire to access data associated with first entity 110 in order to improve the responsiveness and/or usefulness of the application to first entity 110. It is to be understood that these are merely illustrative examples, and that system 100 may be used in a variety of other contexts and/or with different types of entities corresponding to first entity 110 and/or second entity 120. For example, each of first entity 110 and/or second entity 120 may correspond to an individual person, a group of individuals, an organization, and/or the like.

First entity 110 and/or second entity 120 may communicate with system 100 via a network 130. In some embodiments, network 130 may support a variety of wired communication protocols, wireless communication protocols, and/or the like. For example, network 130 may include a packet-switched network configured to provide digital networking communications and/or to exchange data of various forms, content, type, and/or structure. In some embodiments, network 130 may include a data network, a private network, a local area network, a wide area network, the Internet, a telecommunications network, and/or a cellular network, among other possible networks. In some instances, the network 130 may include network nodes, web servers, switches, routers, base stations, microcells, and/or various buffers/queues to transfer data/data packets.

System 100 may include a server 140 with a data module 145 to access, obtain, and/or store data associated with first entity 110. In some embodiments, server 140 may interact with first entity 110 via network 130. For example, server 140 may perform operations of a service provider, such as PayPal, Inc. of San Jose, Calif., USA. In this regard, first entity 110 may provide data to server 140 when using a service of the service provider. For example, first entity 110 may establish an account with the service provider via server 140. In doing so, first entity 110 may provide, and data module 145 may collect, data associated with first entity 110, including personal data (e.g., name, residence address, email address, telephone number, social security number, age, and/or the like), financial data (e.g., bank account number, credit card number, credit eligibility, spending habits, and/or the like), and/or the like.

When first entity 110 accesses and/or uses a service via server 140, data module 145 may collect usage data and/or transaction data associated with first entity 110. For example, data module 145 may collect networking data (e.g., click stream, browsing history, device type, IP address, and/or the like), geolocation data, and/or the like. In further examples, data module 145 may collect transaction data associated with first entity 110, such as a history of purchases (e.g., item, price, merchant, location, and/or the like). Similarly, data module 145 may collect social data associated with first entity 110, such as a social networking graph (e.g., business, personal, and/or family connections), social media activity, and/or the like.

In some embodiments, data module 145 may obtain data associated with first entity 110 (e.g., personal data, financial data, usage data, transaction data, social data, and/or the like) from one or more third party data providers 150. That is, in addition to and/or as an alternative to collecting data based on interactions and/or transactions between first entity 110 and server 140, data module 145 may obtain the data from one or more third parties. In some embodiments, the data obtained from third party data providers 150 may supplement and/or augment the data obtained via server 140. For example, when server 140 provides a payment service used by a first set of online merchants, third party data providers 150 may provide transaction data from a second set of online merchants that do not use the payment service of server 140. In this manner, data module 145 may obtain a more comprehensive set of transaction data associated with the first entity 110 than server 140 alone provides.

In some embodiments, third party data providers 150 may correspond to virtually any source of data associated with first entity 110. For example, third party data providers 150 may include a data clearinghouse, an analytics service, a risk management service, a credit reporting agency, a product information platform, a merchant and/or business entity, and/or various other types of entities that possess data associated with first entity 110. The data provided by third party data providers 150 may be directly associated with first entity 110 (e.g., a transaction history of first entity 110) or indirectly associated with first entity 110 (e.g., metadata associated with a product purchased by first entity 110). In some embodiments, data module 145 may transform and/or process the data provided by third party data providers 150 as appropriate. For example, data module 145 may denormalize and/or filter the obtained data in accordance with various rules and/or policies to assist in the storage and/or retrieval of the data.

Some types of data associated with first entity 110 obtained by data module 145 may be sensitive, private, and/or susceptible to misuse. For example, the data may be used, either in isolation and/or when combined with other types of data, to personally identify first entity 110 and/or to obtain unauthorized access to accounts associated with first entity 110. The collection, storage, retrieval, and/or usage of such data may be subject to various restrictions and/or scrutiny, legal or otherwise. For example, access to certain types of data may be restricted by government and/or industry regulations, company privacy policies, consumer pressure, and/or various other legal, political, economic, and/or social forces. Such barriers to the use of data may be especially heightened when sharing personal data with third parties.

On the other hand, the ability to share data associated with first entity 110 with one or more third parties, such as second entity 120, may have significant value. For example, second entity 120 may desire to use data associated with first entity 110 to create and/or enhance services provided to first entity 110. For instance, second entity 120 may be a merchant and/or website operator who desires to attract and/or retain the business of first entity 110 using an informed, data-driven approach. In this regard, the ability to share the data collected by data module 145 with second entity 120 may improve the operation of a website operated by second entity 120. Accordingly, it would be desirable for system 100 to allow second entity 120 to access data associated with first entity 110 while implementing safeguards to address associated privacy and/or security issues.

However, there are significant technical challenges associated with implementing safeguards to address privacy and/or security issues associated with data collected via data module 145. In particular, some types of data—e.g., personal data and/or other types of sensitive data—may be access-restricted and/or unshareable. To address these restrictions on access and/or sharing, the data may be transformed, aggregated, anonymized, and/or otherwise processed in order to facilitate sharing. While certain types of transformations and/or data processing steps may be performed by humans and/or other pre-existing approaches, these approaches may be inadequate in the context of system 100. In particular, the volume of data handled by system 100 and the desire for high reliability and security may exceed the limited pattern-detection ability of humans and/or the limited ability of humans to perform tasks reliably according to a rules-based approach. To address these challenges, system 100 may store and retrieve data using computer-implemented techniques, including machine learning techniques, as described below.

According to some embodiments, system 100 may include a data store 160 coupled to data module 140. Data store 160 is used to store and retrieve data associated with first entity 110 obtained via data module 140. Data store 160 may implement one or more databases, such as structured query language databases, relational databases, non-relational databases, XML databases, and/or the like. In some embodiments, data store 160 may store data hierarchically (e.g., using a structured file system) and/or in a flat architecture (e.g., using a data lake). In some embodiments, data store 160 may include a processor 162 (which may include one or more hardware processors) and a memory 164 (which may include one or more non-transitory memories), any of which may be communicatively linked via a system bus, network, or other connection mechanism. Processor 162 may take the form of a multi-purpose processor, a microprocessor, a special purpose processor, a digital signal processor (DSP) and/or other types of processing components. For example, processor 162 may include an application specific integrated circuit (ASIC), a programmable system-on-chip (SOC), and/or a field-programmable gate array (FPGA). Memory 164 may take the form of a hard disk drive, a solid state drive, a random access memory (e.g., DRAM, SRAM, and/or the like), a non-volatile memory, magnetic tape, punch cards, and/or other types of memory components.

In some embodiments, data store 160 may be used to store and retrieve various types of data associated with first entity 110 and/or any number of additional entities, including base data 166. In general, base data 166 corresponds to raw data collected by data module 145. For example, base data 166 may be represented as a table where each row corresponds to a particular entity and each column corresponds to a particular type of data collected by data module 145 (e.g., the name of the entity, the address of the entity, the transaction history of the entity, and/or the like). In some examples, base data 166 may include one or more types of access-restricted data that should not be shared, e.g., due to privacy and/or regulatory concerns. Accordingly, various security measures may be taken to protect base data 166. For example, base data 166 may be encrypted and/or access to base data 166 may be limited. Additionally or alternately, base data 166 and/or at least a portion of memory 164 used to store base data 166 may be located in a physically secure environment. Similarly, network access to base data 166 may be secured to prevent unauthorized access.

In some embodiments, data store 160 may optionally be used to store and retrieve derivative data 168a-c. As depicted in FIG. 1, derivative data 168a-c includes predictive data 168a, aggregate data 168b, and recommendation data 168c. In general, derivative data 168a-c is derived from base data 166. In some embodiments, access-restricted data included in base data 166 may be processed (e.g., transformed, anonymized, and/or the like) in order to render derivative data 168a-c shareable in light of applicable legal, ethical, and/or other related duties. For example, derivative data 168a-c may be anonymized to prevent and/or reduce the likelihood that the identity of and/or sensitive details associated with first entity 110 may be ascertained based on derivative data 168a-c.

Although derivative data 168a-c is depicted in FIG. 1 as being persistent in memory 164, it is to be understood that various alternatives are possible. For example, derivative data 168a-c may be generated on-demand from base data 166 (e.g., by processor 162) without being stored in memory 164. Moreover, although base data 166 and derivative data 168 are depicted as independent data structures, it is to be understood that base data 166 and derivative data 168a-c may be implemented using one or more combined data structures. For example, base data 166 and derivative data 168a-c may be stored in a combined data table in which base data 166 and derivative data 168a-c correspond to different columns. In some embodiments, derivative data 168a-c may be subject to similar security measures as base data 166 (e.g., encryption, physical security, network security and/or the like). However, in some embodiments, derivative data 168a-c may be subject to less stringent security measures than base data 168 due to the generally lower sensitivity of derivative data 168a-c.

In some embodiments, predictive data 168a may include one or more predictions and/or preferences associated with first entity 110 and/or any number of additional entities. In general, predictive data 168a may be used to classify and/or characterize first entity 110, identify first entity 110 as being a member of one or more groups, predict future activities of first entity 110, extrapolate past activities of first entity 110, and/or the like. For example, predictive data 168a may identify a vertical associated with first entity 110, e.g., an industry and/or type of product that is likely to be of interest to first entity 110 (e.g., fashion, housewares, toys, gaming, travel, music, and/or the like). Additionally or alternately, predictive data 168a may identify particular products, services, travel destinations, and/or the like that are likely to be of interest to first entity 110. Although the preceding examples generally focus on commercial applications of system 100 (e.g., predictive data that would be useful to a merchant attempting to sell something to first entity 110), it is to be understood that predictive data 168a may include various other types of predictions and/or preferences associated with first entity 110, including non-commercially focused predictions. For example, predictive data 168a may be used for law enforcement applications (e.g., to predict a likelihood of criminal activity), academic applications (e.g., to predict the level of expertise that first entity 110 has in a given subject matter), and/or the like.

In some embodiments, aggregate data 168b may include one or more aggregate statistics and/or metrics associated with first entity 110 and/or any number of additional entities. In general, first entity 110 may be a member of one or more groups and/or cohorts. For example, base data 166 and/or predictive data 168a may identify first entity 110 as being a member of a group based on attributes such as location, age, gender, previous activities (e.g., purchasing habits), and/or the like. Accordingly, aggregate data 168b may include statistics associated with one or more of the groups of which first entity 110 is a member. For example, aggregate data 168 may identify the vertical that the age cohort of first entity 110 (e.g., 18-25 year olds) is most likely to be interested in and/or to purchase from. As will be understood by one skilled in the art, aggregate data 168b may additionally or alternately include a wide variety of statistics used in fields such as consumer marketing, demographic surveys, and/or the like.

In some embodiments, recommendation data 168c may include one or more recommendations associated with first entity 110 and/or any number of additional entities. Recommendations may include natural language and/or textual recommendations based on base data 166, predictive data 168a, and/or aggregate data 168b associated with first entity 110. For example, when predictive data 168a identifies a particular vertical (e.g., “shoes”) as being of likely interest to first entity 110, recommendation data 168c may include an instruction to “sell shoes.” Likewise, when aggregate data 168b indicates that first entity 110 is in an age and/or fitness cohort that is likely to suffer from high blood pressure, recommendation data 168c may include an instruction to “check blood pressure.” In some embodiments, recommendation data 168c be based on contextual information associated with first entity 110, second entity 120, and/or the like. For example, when second entity 120 is a merchant, recommendation data 168c may include the instruction to “sell shoes,” whereas when second entity 120 is a medical professional, recommendation data 168c may include the instruction to “check blood pressure.”

According to some embodiments, the types of derivative data 168a-c may be selected to obfuscate access-controlled data contained in base data 166. As discussed above, unlike base data 166, derivative data 168a-c (including predictive data 168a, aggregate data 168b, and/or recommendation data 168c) generally does not include information that uniquely identifies first entity 110. Moreover, derivative data 168a-c may offer varying levels of generality. For example, as discussed previously, predictive data 168a may identify a list of the top ten verticals favored by first entity 110. While such data may obscure the identity of first entity 110 relative to base data 166 to some extent, it may be still be possible to narrow down the number of possible entities that share the same or similar list to a small number. On the other hand, recommendation data 168c may include an instruction to “sell toys.” Such an instruction is highly generic and unlikely to significantly narrow down the identity of first entity 110.

System 100 may include a server 170 with an access control module 175 to retrieve data associated with first entity 110 from data store 160. In some embodiments, server 170 may interact with second entity 120 via network 130. In some embodiments, server 170 may provide information from data store 160 to second entity 120 in response to receiving a request from second entity 120. For example, server 170 may implement an application programming interface (API), a hypertext transfer protocol (HTTP) server, a file transfer protocol (FTP) server, and/or the like. In some embodiments, server 170 may provide secure and/or encrypted methods of interaction with second entity 120, such as secure socket layer (SSL) communication, secure HTTP (HTTPS), secure FTP (SFTP), and/or the like. Consistent with such embodiments, data may be transferred between server 170 and second entity 120 using a suitable serialization format, such as JavaScript object notation (JSON), XML, protocol buffers, and/or the like. In an illustrative embodiment, server 170 may be configured to respond to a GET request using a REST API. The GET request may originate from a web client, a mobile application, a desktop application, and/or the like.

According to some embodiments, server 170 and/or access control module 175 may determine a level of access of second entity 120 when retrieving data associated with first entity 110 on behalf of second entity 120. For example, the level of access may be determined based on a relationship between second entity 120 and the provider of system 100 (e.g., a customer tier of second entity 120, a contractual arrangement between second entity 120 and the provider, and/or the like). In some examples, the level of access may be determined based on a relationship between second entity 120 and first entity 110. For example, the level of access may be higher when second entity 120 has obtained consent from first entity 110 than when second entity 120 has not obtained consent to access data associated with first entity 110. In further examples, the level of access may be determined based on a relationship between the provider of system 100 and first entity 110. For example, the level of access may be higher when system 100 obtains data directly from first entity 110 than when system 100 obtains the data through third party data provider 150.

In some embodiments, access control module 175 may determine the level of access of second entity 120 based on information included in a request received from second entity 120. For example, second entity 120 may perform an authentication and/or authorization process with system 100, in which case the request may include a verification that second entity 120 is authenticated (e.g., an authorization token). In some examples, the request may include an indication of whether second entity 120 has obtained consent from first entity 110 to access certain types of data associated with first entity 110.

Based on the level of access of second entity 120, server 170 may retrieve the requested data from data store 160. In some embodiments, the level of access may identify one or more types of data that second entity 120 is entitled to access (e.g., base data 166, predictive data 168a, aggregate data 168b, recommendation data 168c, and/or any combination thereof). In some embodiments, the level of access may identify specific data fields that second entity 120 is entitled to access (e.g., a set of indices and/or a binary mask that permits access to specified rows and/or columns of a data table stored in memory 164). In some embodiments, retrieving the requested data may include accessing the data from memory 164 and/or generating data (e.g., derivative data 168a-c) on demand by processor 162.

Although server 140, data store 160, and server 170 are depicted as independent subsystems of system 100 in FIG. 1, one of ordinary skill in the art would recognize that many alternative arrangements are possible. In some embodiments, server 140, data store 160, and server 170 may be implemented using any number of discrete devices. For example, server 140, data store 160, and server 170 may be implemented on the same device and/or may share processing and/or memory resources. Likewise, server 140, data store 160, and server 170 may be implemented in a virtualized and/or containerized computing environment, e.g., using public and/or private cloud computing facilities.

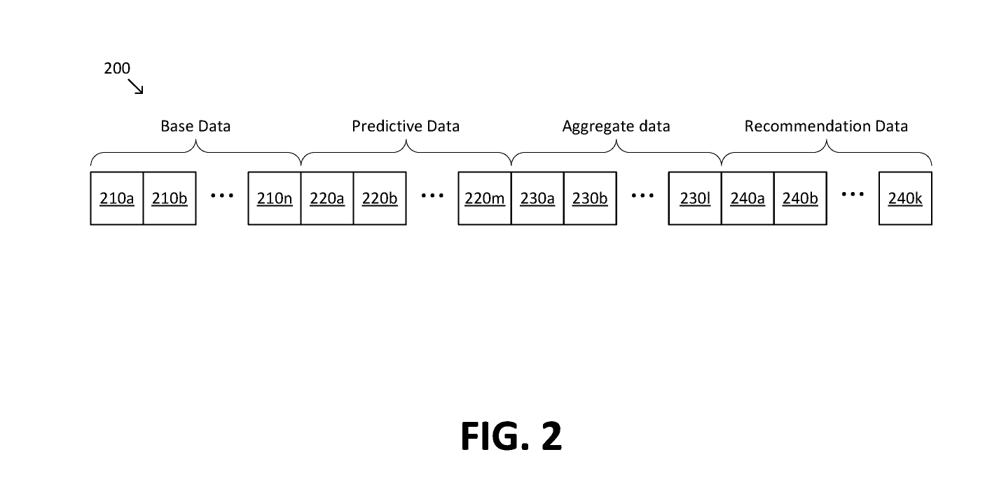

FIG. 2 is a simplified diagram of a response template 200 according to some embodiments. According to some embodiments consistent with FIG. 1, response template 200 may be used to transmit data associated with one or more entities, such as first entity 110, between server 170 and second entity 120. Consistent with such embodiments, response template 200 may be populated with data from a data store, data store 160, in response to a request from second entity 120 to access data associated with first entity 110. For example, response template 200 may be populated by retrieving stored data from memory 164, generating data on demand by processor 162, and/or any combination thereof. In some embodiments, response template 200 may be populated based on an access level of second entity 120. In some embodiments, response template 200 may correspond to a JSON data structure and/or any other serialized data format suitable for transmission over network 130.

In some embodiments, response template 200 may include one or more base data fields 210a-n, which may be used to transmit base data associated with first entity 110, such as base data 166. As depicted in FIG. 2, response template 200 includes n fields assigned to base data fields 210a-n. For example, base data fields 210a-n may be used to transmit various types of access-restricted data associated with first entity 110, e.g., sensitive information that may be used to identify first entity 110, obtain unauthorized access to an account of first entity 110, and/or the like. In some embodiments, base data fields 210a-n may be transmitted in an encrypted format.

In some embodiments, response template 200 may further include predictive data fields 220a-m, which may be used to transmit predictive data associated with first entity 110, such as predictive data 168a. As depicted in FIG. 2, response template 200 includes m fields assigned to predictive data fields 220a-m. For example, predictive data fields 220a-n may be used to transmit various types of predictions and/or preferences associated with first entity 110 that are derived from base data 166.

In some embodiments, response template 200 may further include aggregate data fields 230a-l, which may be used to transmit aggregate data associated with first entity 110, such as aggregate data 166b. As depicted in FIG. 2, response template 200 includes l fields assigned to aggregate data fields 230a-l. For example, aggregate data fields 230a-l may be used to transmit various types of statistics associated with a group and/or cohort of which first entity 110 is a member.

In some embodiments, response template 200 may further include recommendation data fields 240a-k, which may be used to transmit recommendation data associated with first entity 110, such as recommendation data 166c. As depicted in FIG. 2, response template 200 includes k fields assigned to recommendation data fields 240a-k. For example, recommendation data fields 240a-k may be used to transmit instructions and/or recommendations to second entity 120 based on any of the previously discussed information associated with first entity 110 (e.g., base data, predictive data, and/or aggregate data).

As discussed previously, although response template 200 may include any number of fields for data corresponding to base data and/or derivative data (e.g., predictive data, aggregate data, and/or recommendation data), the response that is actually generated and transmitted to second entity 120 may contain fewer data fields than those included in response template 200. In particular, portions of response template 200 may correspond to restricted-access data and/or data that cannot otherwise be shared with second entity 120, as determined based on the level of access of second entity 120. For example, second entity 120 may not have access to base data associated with first entity 110. In such examples, base data fields 210a-n (and/or any other fields of response template 200 that second entity 120 does not have access to) may not be populated and/or may be omitted when sending a response to second entity 120.

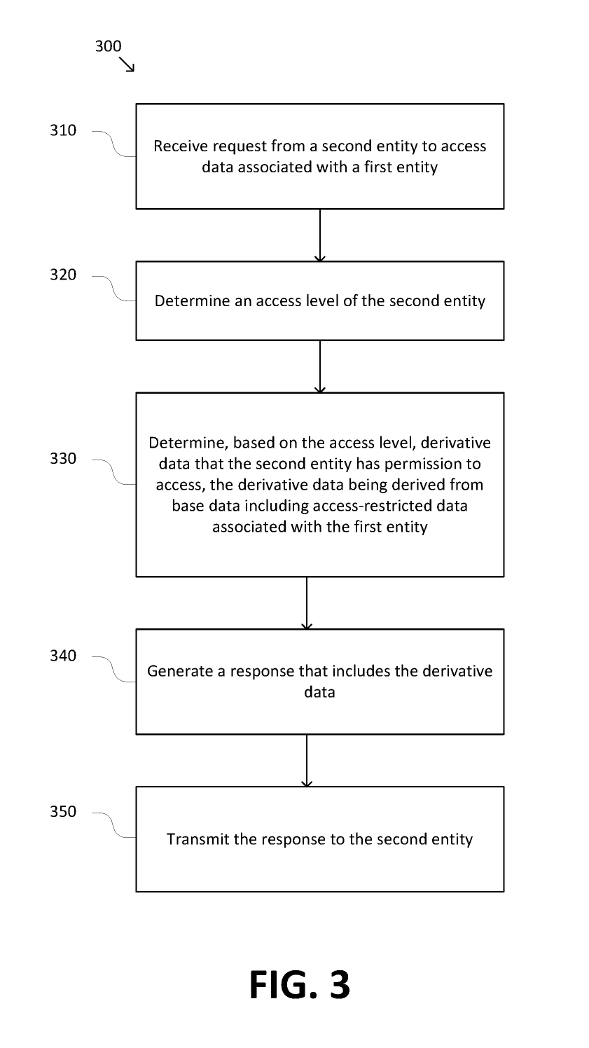

FIG. 3 is a simplified diagram of a method 300 for retrieving data associated with a first entity, such as first entity 110, according to some embodiments. In some embodiments consistent with FIG. 1, method 300 may be performed by a processor, such as a processor of server 170 and/or processor 162 of data store 160.

At a process 310, a request is received from a second entity, such as second entity 120, to access data associated with the first entity. In some embodiments, the request may include a request transmitted over a network (e.g., network 130), such as an API request, an HTTP request, an FTP request, and/or the like. The request may be transmitted from any suitable endpoint associated with the second entity, such as a web browser, an application on a mobile device, a desktop application, and/or the like.

At a process 320, an access level of the second entity is determined. In some embodiments, the access level may be determined based on information included in the request. For example, the second entity may have previously performed an authentication and/or authorization process, in which case the request may include an authorization token that identifies (or may be used to identify) the access level of the second entity. The access level may be represented as a score, a set of permissions, and/or any other suitable representation. In some embodiments, the access level may be determined based on a consent of the first entity. For example, an indication that the first entity has given consent to access particular types of data may be included in the request and/or may be obtained separately. In some embodiments, the access level may be determined by an access control module, such as access control module 175.

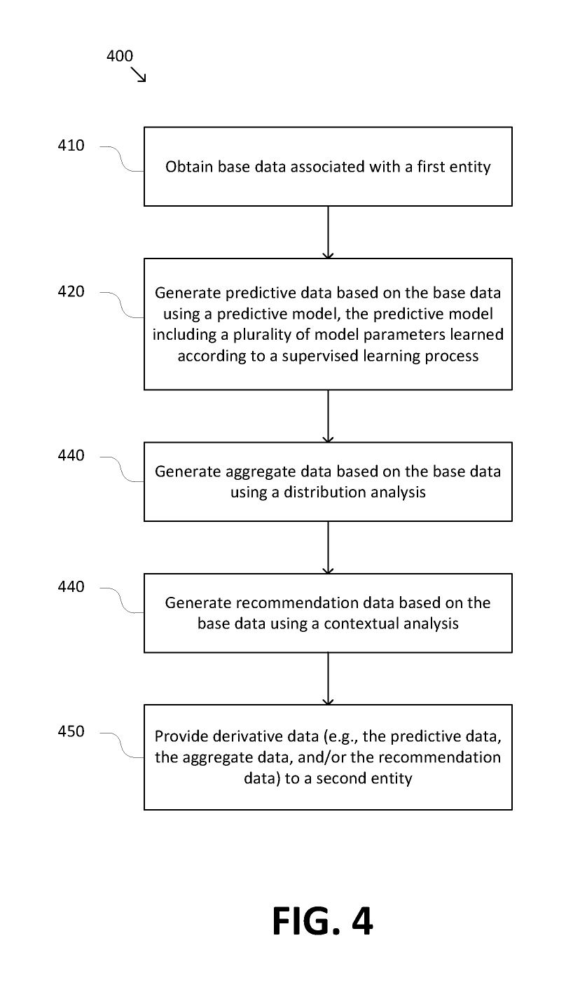

At a process 330, derivative data that the second entity has permission to access is determined based on the access level. In some embodiments, the derivative data may be derived from base data associated with the first entity, such as base data 166. In some embodiments, the base data may include access-restricted data associated with the first entity. For example, the base data may include sensitive data that may be used to uniquely identify the first entity and/or to obtain unauthorized access to an account of the first entity. Accordingly, the base data (and/or portions thereof) may be unshareable in order to protect the privacy and/or security of the first entity. By contrast, the derivative data may be formed by processing the base data to scrub access-restricted data from the output. In this regard, unlike the base data, the derivative data may not uniquely identify the first entity or otherwise convey sensitive information to the second entity (or at least, the process of extracting sensitive information from the derivative data may be substantially more difficult than from the base data). Techniques for generating derivative data from base data are described in greater detail below with reference to FIG. 4.

Different types of derivative data may convey varying levels of detail about the first entity to the second entity. For example, predictive data, such as predictive data 168a, may provide detailed insights into the preferences and/or predicted future behaviors of the first entity. Meanwhile, recommendation data, such as recommendation data 168c, may provide little or no information that is specifically attributable to the first entity. Accordingly, the types of derivative data that the second entity has as permission to access may vary based on the access level. For example, when the access level is below a first threshold, the derivative data determined at process 330 may include the recommendation data. When the access level is above the first threshold and below a second threshold, the derivative data determined at process 330 may include the recommendation data and aggregate data, such as aggregate data 168b. When the access level is above the second threshold, the derivative data determined at process 330 may include the recommendation data, the aggregate data, and the predictive data. In some embodiments, the access level may be sufficiently high (e.g., administrator-level access and/or owner-level access) to provide full access to data associated with the first entity, including base data as well as various types of derivative data.

At a process 340, a response that includes the derivative data is generated. In some embodiments, the response may be generated by populating a response template, such as response template 200. In some examples, the response may be generated by accessing the derivative data from a data store, such as data store 160. As discussed previously, the response may be formatted according to a variety of message types, such as a JSON response message, and XML response message, and/or the like.

At a process 350, the response is transmitted to the second entity. In some embodiments, the response may be transmitted over a network, such as network 130. Although the preceding embodiments generally describe the response as an API response message, it is to be understood that various alternatives are possible. For example, the response may be transmitted to the second entity by email, SMS, and/or another suitable messaging service.

FIG. 4 is a simplified diagram of a method 400 for generating derivative data, such as derivative data 168a-c, from base data, such as base data 166, according to some embodiments. According to some embodiments consistent with FIG. 1, the operations of method 400 may be performed by a processor, such as a processor of server 170 and/or processor 162 of data store 160. In some embodiments, method 400 may be performed at various times and/or upon the occurrence of one or more triggers. For example, the triggers may include receiving new and/or updated base data and/or receiving a request from a second entity, such as second entity 120. In some embodiments, method 400 may be performed automatically according to a schedule and/or on a periodic basis.

At a process 410, base data associated with a first entity, such as first entity 110, is obtained. In some embodiments, the base data may be retrieved from a memory, such as memory 164. In some embodiments, the base data may have been collected from a variety of sources, including directly from the first entity, from one or more third party data sources, such as third party data sources 150, and/or the like. As discussed previously, the base data may include access-restricted information associated with the first entity that is unshareable due to privacy and/or security concerns.

At a process 420, predictive data, such as predictive data 168a, is generated based on the base data using a predictive model. In some embodiments, the predictive model may include a machine learning model, a rules-based model, and/or the like. For example, the predictive model may include a plurality of model parameters learned according to a supervised learning process. In some embodiments, the supervised learning process may include training the predictive model using a set of training data, which may include thousands and/or millions of training examples. An illustrative example of training data includes a transaction history of an entity and a preferred vertical of the entity, with the latter serving as a label for the supervised learning process. By training the predictive model over many examples of such training data, the predictive model may learn to accurately identify a preferred vertical of an entity based on a transaction history. More generally, the predictive model may learn to accurately classify an entity in any number of ways based on the base data. Notably, although the input of the predictive model includes base data that may be of a highly personal nature (e.g., a transaction history of the first entity), the output of the predictive model is a broad classification (e.g., a preferred vertical of the first entity) that is generally not personal to the entity.

According to some embodiments, various precautions may be taken at process 420 to ensure that the predictive data does not include access-restricted data (including remnants and/or artifacts of the access-restricted data that may remain even after being processed by the predictive model). In some embodiments, certain types the base data containing access-restricted data may be marked as unusable and/or otherwise not included in the input to the predictive model. This approach may be particularly useful when the access-restricted data is highly personal (which can be defined by the system and/or the entity/user associated with the data) and/or is unlikely to improve the accuracy of the model. For example, the full name of the first entity may be marked as unusable because it clearly identifies the first entity and is generally unlikely to have significant predictive value. In some embodiments, certain types of base data containing access-restricted data may be modified and/or altered to reduce the sensitivity of the data that is input into the predictive model. This approach may be particularly useful when the access-restricted data is highly personal but is likely to improve the accuracy of the model. For example, the street address of the first entity may be stripped down to a zip code and/or a city of residence to reduce the amount of personal information conveyed. Likewise, the phone number of the first entity may be stripped down to an area code. In this manner, the personally identifiable aspects of the data are reduced while retaining the more general geographic location information, which may improve the accuracy of the predictive model.

At a process 430, aggregate data, such as aggregate data 168b, is generated based on the base data and/or the predictive data using a distribution analysis. According to some embodiments, the distribution analysis may include a statistical analysis of a group and/or cohort of which the first entity is a member. Membership in a group may be determined directly from the base data (e.g., when the base data includes an age of the first entity, the age cohort may be directly determined) and/or from derivative data, such as the predictive data determined at process 420 (e.g., when the base data does not include the age of the first entity, the age cohort may be predicted using an age predictive model). Examples of statistical analyses that may be included in the aggregate data include a mean (e.g., average spending of a particular age cohort), a total (e.g., a total market size of a particular age cohort), variance, trends, risk assessments, and/or the like.

At a process 440, recommendation data, such as recommendation data 168c, is generated based on the base data using a contextual analysis. In some embodiments, the contextual analysis may use contextual information about the first entity, the second entity, and/or the like to generate a recommendation for the second entity with respect to the first entity. For example, the recommendation when the second entity is a merchant (e.g., “sell shoes”) may be different than the recommendation when the second entity is a medical professional (e.g., “check blood pressure”). According to some embodiments, the contextual analysis may use a recommendation model, which may include a machine learning model. Like the predictive model used in process 420, the recommendation model may include a plurality of model parameters (e.g., weights and/or biases) that are learned according to a supervised learning process. The inputs to the recommendation model may include base data, predictive data, aggregate data, and/or contextual data (e.g., data that identifies the identity and/or a desired objective of the second entity), and the output may include one or more recommended actions. In some examples, a natural language engine may be used to render the recommendation into natural language text (e.g., a verb-noun command).

At a process 450, derivative data (e.g., the predictive data, the aggregate data, and/or the recommendation data generated at processes 420-440) is provided to a second entity. In some embodiments, the derivative data may be provided in response to a request from the second entity as described in method 300. Consistent with such examples, the derivative data (and/or a portion thereof) may be provided based on an access level of the second entity. It is to be understood that various processes 410-440 may be rearranged and/or omitted from method 400. For example, when a request is received from a second entity that has permission to access the recommendation data but not predictive data and/or aggregate data, method 400 may include processes 410 and 440 but may omit processes 420 and/or 430. In this manner, the derivative data provided at process 450 may include the particular types of derivative data that the second entity has permission to access.

The present disclosure, the accompanying figures, and the claims are not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure.

1. A system for storing and retrieving data, comprising:
a non-transitory memory; and
one or more hardware processors coupled to the non-transitory memory and configured to read instructions from the non-transitory memory to cause the system to perform operations comprising:
obtaining base data associated with a first entity, wherein the base data includes access-restricted data associated with the first entity;
generating predictive data based on the base data using a predictive model, the predictive model including a plurality of model parameters learned according to a supervised learning process, wherein the predictive data does not include the access-restricted data; and
providing the predictive data to a second entity.

2. The system of claim 1, wherein the base data is obtained directly from the first entity.

3. The system of claim 1, wherein the base data is obtained from one or more third party data sources.

4. The system of claim 1, wherein the base data includes combined data obtained from a plurality of third party data sources.

5. The system of claim 1, wherein the operations further comprise generating aggregate data based on the base data using a distribution analysis.

6. The system of claim 5, wherein the distribution analysis includes determining a membership of the first entity in one or more groups.

7. The system of claim 5, wherein the operations further comprise generating recommendation data based on the base data using a contextual analysis.

8. The system of claim 7, wherein one or more of the predictive data, the aggregate data, or the recommendation data are provided to the second entity based on a level of access of the second entity.

9. The system of claim 1, wherein the operations further comprise marking one or more types of base data as unusable, wherein the one or more types of base data marked as unusable are not used by the predictive model to generate the predictive data.

10. The system of claim 1, wherein the second entity corresponds to a merchant and the first entity corresponds to a prospective customer of the merchant.

11. A non-transitory machine-readable medium having stored thereon machine-readable instructions executable to cause a machine to perform operations comprising:
obtaining base data associated with a first entity, wherein the base data includes access-restricted data associated with the first entity;
generating predictive data based on the base data using a predictive model, the predictive model including a plurality of model parameters learned according to a supervised learning process, wherein the predictive data does not include the access-restricted data; and
providing the predictive data to a second entity based on an access level of the second entity.

12. The non-transitory machine-readable medium of claim 11, wherein the operations further comprise generating aggregate data based on the base data using a distribution analysis.

13. The non-transitory machine-readable medium of claim 12, wherein the distribution analysis includes determining a membership of the first entity in one or more groups.

14. The non-transitory machine-readable medium of claim 12, wherein the operations further comprise generating recommendation data based on the base data using a contextual analysis.

15. The non-transitory machine-readable medium of claim 14, wherein one or more of the predictive data, the aggregate data, or the recommendation data are provided to the second entity based on a level of access of the second entity.

16. A method for retrieving data associated with a first entity, comprising:
receiving a request from a second entity to access the data associated with the first entity;
determining an access level of the second entity;
determining, based on the access level, derivative data that the second entity has permission to access, the derivative data being derived from base data that includes access-restricted data associated with the first entity;
generating a response that includes the derivative data; and
transmitting the response to the second entity.

17. The method of claim 16, wherein the derivative data includes one or more of predictive data, aggregate data, and recommendation data.

18. The method of claim 17, wherein the derivative data includes:
the recommendation data when the access level is below a first threshold;
the recommendation data and the aggregate data when the access level is above the first threshold and below a second threshold; and
the recommendation data, the aggregate data, and the predictive data when the access level is above the second threshold.

19. The method of claim 16, wherein generating the response includes populating a response template.

20. The method of claim 16, wherein the request and the response correspond to a pair of application programming interface (API) messages.
